(19) United States
(12) Patent Application Publication
(10) Pub. No.: US 2026/0120006 A1
(43) Pub. Date: Apr. 30, 2026

(54) METHOD AND SYSTEM FOR DEFINING SPATIAL RENEWAL INTENSITY OF RAIL TRANSIT STATION REGION BASED ON MULTI-PARAMETER COLLABORATION

(71) Applicant: SOUTHEAST UNIVERSITY, Nanjing (CN)

(72) Inventors: Yuan ZHU, Nanjing (CN); Hui LI, Nanjing (CN)

(73) Assignee: SOUTHEAST UNIVERSITY, Nanjing (CN)

(21) Appl. No.: 19/011,609

(22) Filed: Jan. 7, 2025

Related U.S. Application Data
(63) Continuation of application No. PCT/CN2024/095717, filed on May 28, 2024.

(30) Foreign Application Priority Data
Dec. 22, 2023 (CN) 202311781407.8

(51) Int. Cl. G06Q 50/16; G06Q 10/04; G06Q 50/08

(52) U.S. Cl. CPC G06Q 10/04; G06Q 50/08; G06Q 50/163

(57) ABSTRACT

A method and system for defining a spatial renewal intensity of a rail transit station region based on multi-parameter collaboration are provided. The method includes: receiving an initial sample region, and defining a scope of the initial sample region to obtain plots within the station region; dividing the plots within the station region to obtain different renewal types of plots, and calculating station renewal intensity definition indicators; performing correlation analysis on the station renewal intensity definition indicators to obtain analysis results, generating different analysis groups, and obtaining rail transit station intensity characteristic research elements, where the rail transit station intensity characteristic research elements correspond to the station renewal intensity definition indicators; and receiving sample stations, designating the station renewal intensity definition indicators of the sample stations corresponding to different rail transit station intensity characteristic research elements as input variables, and performing clustering analysis to obtain definition results.

### CROSS REFERENCE TO THE RELATED APPLICATIONS

This application is a continuation application of International Application No. PCT/CN2024/095717, filed on May 28, 2024, which is based upon and claims priority to Chinese Patent Application No. 202311781407.8, filed on Dec. 22, 2023, the entire contents of which are incorporated herein by reference.

### TECHNICAL FIELD

The present invention relates to the technical field of spatial renewal intensity evaluation of rail transit station regions, specifically to a method and system for defining a spatial renewal intensity of a rail transit station region based on multi-parameter collaboration.

### BACKGROUND

After a development stage of rapid urbanization, China's urban spatial pattern and land use have gradually stabilized, and the focus of city development has shifted to perfecting city functions and improving spatial quality. Meanwhile, the promotion of low-carbon travel in cities, accompanied by large-scale construction of rail transit, has brought good opportunities for urban renewal.

In order to fully utilize the land value around a station, the development intensity is often increased. However, the stable land structure and complex ownership of urban built-up regions make it difficult to increase the development intensity on a large scale in an incremental manner, so refined development intensity evaluation methods are required. At present, the evaluation methods mainly focus on development intensity to assess urban land use and urban capacity and comprehensively reflect the degree of urban land use and spatial carrying capacity. Indicators for measuring the development intensity usually include building area, population size, and employment scale. These indicators exhibit multi-level, multi-purpose, multi-factor, complexity, and dynamic characteristics. However, currently in China's regulatory detailed planning and land transfer conditions, the indicators of development intensity mainly focus on plot ratio, which leads to the problem of one-sided analysis dimension; and the existing development intensity evaluation methods are difficult to adapt to the development of urban spatial renewal of a rail transit station region in the context of urban renewal, and cannot fully reflect the degree of change.

### SUMMARY

To solve the shortcomings mentioned in the background, the objective of the present invention is to provide a method and system for defining a spatial renewal intensity of a rail transit station region based on multi-parameter collaboration.

The objective of the present invention can be achieved by the following technical solution: A method for defining a spatial renewal intensity of a rail transit station region based on multi-parameter collaboration includes the following steps:

receiving an initial sample region, and defining a scope of the initial sample region to obtain plots within the station region, where the initial sample region is divided by surrounding regions of rail transit stations;
dividing the plots within the station region to obtain different renewal types of plots, and calculating station renewal intensity definition indicators using the different renewal types of plots;
performing correlation analysis on the station renewal intensity definition indicators to obtain analysis results, generating different analysis groups according to the analysis results, and obtaining rail transit station intensity characteristic research elements according to the analysis groups, where the rail transit station intensity characteristic research elements correspond to the station renewal intensity definition indicators; and
receiving sample stations, designating the station renewal intensity definition indicators of the sample stations corresponding to different rail transit station intensity characteristic research elements as input variables, and performing clustering analysis to obtain definition results.

Preferably, the plots within the station region are divided into decremental renewal plots, unrenewed plots, stock renewal plots, and incremental renewal plots.

Preferably, the decremental renewal plots refer to plots that originally accommodate building functions and undertook urban functions but are currently demolished for construction or renewed into public spaces such as greenery and squares; the unrenewed plots refer to plots where buildings and land use basically remain unchanged, with improvements only on appearance of some buildings, spatial quality, and urban environment; the stock renewal plots mainly refer to plots where buildings are replaced due to functional requirements or urban spatial planning adjustments and their overall development quantity increases, decreases, or remains unchanged; and the incremental renewal plots refer to plots that are initially planned for construction or unplanned for development, but will be developed for buildings after several years.

Preferably, the station renewal intensity definition indicators include a relative building renewal quantity Q, an absolute building renewal quantity S, a plot ratio renewal quantity V, a building density renewal quantity R, a functional density renewal quantity D, and a functional mix renewal quantity LM.

Preferably, a calculation formula for the relative building renewal quantity Q is as follows:

$$Q = A 1 - A 0$$

where A1 represents a total area of buildings after renewal, A0 represents a total area of buildings before renewal, and Q represents the relative building renewal quantity;
calculation formulas for the absolute building renewal quantity S are as follows:

$$S = \vert Qi \vert$$

$$\sum s = \sum \vert Qi \vert$$

where Qi represents relative renewal quantities of different renewal plot types of buildings (i=1, 2, 3, 4, where 1, 2, 3, 4 represent decremental renewal plots, unrenewed plots, stock renewal plots, and incremental renewal plots, respectively), and S represents the absolute building renewal quantity;
a calculation formula for the plot ratio renewal quantity V is as follows:

$$V = \frac{Q}{SM}$$

where Q represents the relative building renewal quantity; SM represents a total land area; V represents the plot ratio renewal quantity.

Preferably, a calculation formula for the building density renewal quantity R is as follows:

$$R = \frac{{B}_{1} - {B}_{0}}{SM}$$

where B1 represents a total area of building lots after renewal, and B0 represents a total area of building lots after renewal; SM represents the total land area, and R represents the building density renewal quantity;
a calculation formula for the functional density renewal quantity D is as follows:

$$D = \frac{{P}_{1} - {P}_{0}}{SM}$$

where P1 represents a quantity of point of interests (POIs) within the station region after renewal, and P0 represents a quantity of POIs within the station region before renewal; SM represents the total land area; D represents the functional density renewal quantity;
calculation formulas for the functional density renewal quantity LM are as follows:

$${F}_{u} = \frac{{n}_{u}}{N} ( u = 1 , 2 , 3 , ⋯ k )$$

$${LM}_{a} = - {\sum }_{u}^{k} {F}_{u} ln ( {F}_{u} ) ( a = 1 , 0 )$$

$$LM = {LM}_{1} - {LM}_{0}$$

where Fᵤ represents a proportion of u-type functional POIs in a research region, k represents a total number of u types, and nu represents a quantity of u-type functional POIs in the research region; N represents a total quantity of POI data in the research region; LMₐ represents land functional mix within the research scope of the station region, a=1 represents land functional mix after renewal, a=0 represents land functional mix before renewal, and LM represents the functional mix renewal quantity.

Preferably, the process of performing correlation analysis on the station renewal intensity definition indicators uses correlation analysis in statistic package for social science (SPSS) and uses Pearson correlation coefficients for verification, 6 station renewal intensity definition indicators are input as analysis variables, and analysis results about intensities of correlation between different station renewal intensity definition indicators are obtained by the correlation analysis.

Preferably, the rail transit station intensity characteristic research elements include development fluctuation, land use intensity, and functional diversity.

In a second aspect, in order to achieve the above objective, the present invention discloses a system for defining a spatial renewal intensity of a rail transit station region based on multi-parameter collaboration, including:
a scope definition module, configured to receive an initial sample region, and define a scope of the initial sample region to obtain plots within the station region, where the initial sample region is divided by surrounding regions of rail transit stations;
a plot division module, configured to divide the plots within the station region to obtain different renewal types of plots, and calculate station renewal intensity definition indicators using the different renewal types of plots;
a correlation analysis module, configured to perform correlation analysis on the station renewal intensity definition indicators to obtain analysis results, generate different analysis groups according to the analysis results, and obtain rail transit station intensity characteristic research elements according to the analysis groups, where the rail transit station intensity characteristic research elements correspond to the station renewal intensity definition indicators; and
a definition analysis module, configured to receive sample stations, designate the station renewal intensity definition indicators of the sample stations corresponding to different rail transit station intensity characteristic research elements as input variables, and perform clustering analysis to obtain definition results.

In another aspect of the present invention, in order to achieve the above objective, a device is disclosed, including:
one or more processors; and
a memory, configured to store one or more programs, where
when the one or more programs are executed by the one or more processors, the one or more processors are enabled to implement the method for defining the spatial renewal intensity of the rail transit station region based on multi-parameter collaboration as described above.

Beneficial effects of the present invention are as follows:

The present invention provides a scientific and objective evaluation method, which helps government decision-makers, urban planners and developers to make plans and development strategies more wisely. Whether to construct, reconstruct, or retain existing buildings and infrastructures can be determined according to specific renewal intensity data. By evaluating the spatial renewal intensity, the urban planners can better plan land use to ensure optimal utilization of land resources. This helps to reduce unnecessary land waste and increase the value of land. The automatic calculation and data visualization function of the method can improve planning efficiency and reduce the time and cost of decision-making. This makes the urban planning process more efficient and convenient. By comprehensively considering multiple factors, including environmental and social factors, the method can reduce risks in the planning and development process.

### BRIEF DESCRIPTION OF THE DRAWINGS

In order to describe the technical solutions in the embodiments of the present invention or in the prior art more clearly, the following briefly introduces the accompanying drawings required in the description of the embodiments or the prior art. Apparently, those of ordinary skill in the art can derive other drawings from the accompanying drawings without any creative effort.

FIG. 1 is a schematic flowchart of a method of the present invention;

FIG. 2 is a schematic diagram of research elements derived from correlation results of evaluation indicators in the present invention;

FIG. 3 is a distribution diagram of S-Q-V linear relationships in the present invention;

FIG. 4 is a distribution diagram of an R-Q linear relationship and a V-Q linear relationship in the present invention;

FIG. 5 is a distribution diagram of a D-R linear relationship and a D-Q linear relationship in the present invention;

FIG. 6 is a distribution diagram of LM-S-D linear relationships in the present invention;

FIG. 7 is a schematic structural diagram of a system of the present invention;

FIG. 8 is a schematic diagram of a walking range of people within ten minutes in the present invention;

FIG. 9 is an inter-class distance diagram of renewal fluctuation intensity in the present invention;

FIG. 10 is an inter-class distance diagram of land use intensity in the present invention; and

FIG. 11 is an inter-class distance diagram of functional diversity intensity in the present invention.

### DETAILED DESCRIPTION OF THE EMBODIMENTS

The present invention will be further illustrated below in conjunction with the accompanying drawings and specific embodiments. It should be understood that the following specific embodiments are only used to illustrate the present invention and not to limit the scope of the present invention.

### Embodiment 1

Hereinafter, the technical solutions in the embodiments of the present invention will be clearly and completely described in conjunction with the accompanying drawings therein. Apparently, the described embodiments are only some of the embodiments of the present invention, not all of them. All other embodiments obtained by those of ordinary skill in the art based on the embodiments of the present invention without any creative efforts fall within the scope of protection of the present invention.

As shown in FIG. 1, a method for defining a spatial renewal intensity of a rail transit station region based on multi-parameter collaboration includes the following steps:

Receive an initial sample region, and define a scope of the initial sample region to obtain plots within the station region, where the initial sample region is divided by surrounding regions of rail transit stations;

Firstly, a complete region within a certain range around the rail transit station that can be reached by walking for ten minutes is determined as the initial sample region, so a region of 4 km² around the station is selected as the initial sample region; and then starting from each entrance and exit of stations along line 1 in a city, an overlap scope that can be reached by walking for 10 minutes is designated as a research scope. Based on the current road network and the entrances and exits of rail transit stations, a road network dataset is built using Arcgis. The walking speed of people is usually 80-100 mm/min, so a walking range of people within ten minutes is calculated based on 80 m/min.

Divide the plots within the station region to obtain different renewal types of plots, and calculate station renewal intensity definition indicators using the different renewal types of plots;

Divide the plots within the station region into decremental renewal plots, unrenewed plots, stock renewal plots, and incremental renewal plots according to change characteristics before and after renewal.

The decremental renewal plots mainly refer to plots that originally accommodate building functions and undertook urban functions but are currently demolished for construction or renewed into public spaces such as greenery and squares. The unrenewed plots refer to plots where buildings and land use basically remain unchanged, with improvements only on appearance of some buildings, spatial quality, urban environment, etc. The stock renewal plots mainly refer to plots where buildings are replaced due to functional requirements or urban spatial planning adjustments and their overall development quantity may increase, decrease, or remain unchanged, such as renewal of a shantytown into a parking lot. The result of stock renewal is not only an increase in intensity, but also an improvement on people's experience and comfort in space use, and a balance and rationality of urban functions throughout the region are all the significance of stock renewal. The incremental renewal plots refer to plots that are initially planned for construction or unplanned for development, but will be developed for buildings after several years.

The station renewal intensity definition indicators include a relative building renewal quantity Q, an absolute building renewal quantity S, a plot ratio renewal quantity V, a building density renewal quantity R, a functional density renewal quantity D, and a functional mix renewal quantity LM.

Define a difference between a total area of buildings after renewal and a total area of buildings before renewal as the relative building renewal quantity Q. A calculation formula for the relative building renewal quantity Q is as follows:

$$Q = A 1 - A 0$$

In the formula: A1 represents the total area of buildings after renewal, A0 represents the total area of buildings before renewal, and Q represents the relative building renewal quantity.

Compared to Q, |Q| represents an absolute renewal quantity of buildings on plots, reflects a degree of changes in the layout of buildings on the plots, and can better reflect the renewal intensity of the station region. Calculation formulas for the absolute building renewal quantity S are as follows:

$$S = \vert Qi \vert$$

$$\sum s = \sum \vert Qi \vert$$

In the formula: Qi represents relative renewal quantities of different renewal plot types of buildings (i=1, 2, 3, 4, where 1, 2, 3, 4 represent decremental renewal plots, unrenewed plots, stock renewal plots, and incremental renewal plots, respectively), and S represents the absolute building renewal quantity;
Unlike the conventional definition of plot ratio indicators, the plot ratio renewal quantity is a ratio of the relative renewal quantity of buildings on the plots within the station region to an area of the plots. A calculation formula for the plot ratio renewal quantity V is as follows:

$$V = \frac{Q}{SM}$$

In the formula: Q represents the relative building renewal quantity; SM represents a total land area; V represents the plot ratio renewal quantity.

A ratio of a relative renewal quantity of a total building projection area to a plot building land area is defined as the building density renewal quantity, which is used for evaluating spatial environments within the plots and has an important impact on an urban interface. A calculation formula for the building density renewal quantity R is as follows:

$$R = \frac{{B}_{1} - {B}_{0}}{SM}$$

In the formula: B₁ represents a total area of building lots after renewal, and B₀ represents a total area of building lots after renewal; SM represents the total land area, and R represents the building density renewal quantity.

The calculation of the functional density renewal quantity relies on POI information within the station region, which mainly comes from open street maps (OSM). Current functional formats within the rail transit station region before and after renewal are selected for density renewal quantity analysis, which can reflect a change zone of spatial aggregation of targets and a degree of change in region vitality. A calculation formula for the functional density renewal quantity D is as follows:

$$D = \frac{{P}_{1} - {P}_{0}}{SM}$$

In the formula, P₁ represents a quantity of POIs within the station region after renewal, and P₀ represents a quantity of POIs within the station region before renewal; SM represents the total land area; D represents the functional density renewal quantity.

Functional mix is an important indicator for studying functional structures of plots, is essentially a concept of “entropy” in the field of thermodynamics, and is used for reflecting overall disorder of a system. This method mainly considers using a POI data-based urban region functional mix expression method. By referring to functional mix calculation methods in relevant research, calculation formulas for the functional density renewal quantity LM are as follows:

$${F}_{u} = \frac{{n}_{u}}{N} ( u = 1 , 2 , 3 , … k )$$

$${LM}_{a} = - {\sum }_{u}^{k} {F}_{u} ln ( {F}_{u} ) ( a = 1 , 0 )$$

$$LM = {LM}_{1} - {LM}_{0}$$

In the formulas, Fᵤ represents a proportion of u-type functional POIs in a research region, k represents a total number of u types, and nu represents a quantity of u-type functional POIs in the research region; N represents a total quantity of POI data in the research region; LMa represents land functional mix within the research scope of the station region, a=1 represents land functional mix after renewal, a=0 represents land functional mix before renewal, and LM represents the functional mix renewal quantity.

Perform correlation analysis on the station renewal intensity definition indicators to obtain analysis results, generate different analysis groups according to the analysis results, and obtain rail transit station intensity characteristic research elements according to the analysis groups, where the rail transit station intensity characteristic research elements correspond to the station renewal intensity definition indicators;

Correlation analysis in the SPSS and Pearson correlation coefficients for verification are used, and 6 indicators are input as analysis variables. By the correlation analysis, intensities of correlation between different evaluation indicators can be obtained, thereby forming different indicator clusters to guide differentiated research elements related to a rail transit station renewal intensity.

In the field of statistics, a correlation coefficient refers to a quantity that has a linear relationship with two variables and is independent of their structural properties. A Pearson correlation coefficient (PPMCC) is usually used for evaluating a degree of correlation between variables X and Y, and its value ranges from −1 to 1. Therefore, for the same sample, when an indicator has different values, the corresponding correlation coefficient also changes accordingly. According to general determination criteria, a correlation coefficient between 0.0 and 0.2 indicates extremely weak or no correlation, a correlation coefficient between 0.2 and 0.4 indicates weak correlation, a correlation coefficient between 0.4 and 0.7 indicates moderate correlation, and a correlation coefficient between 0.7 and 1.0 indicates strong correlation.

The correlation analysis results of the station renewal intensity indicators are shown in Table 1.

TABLE 1

| | Q | S | V | R | D | LM |
|---|---|---|---|---|---|---|
| Q | 1 | 0.810** | 0.951** | 0.690* | 0.818** | −0.314 |
| S | 0.810** | 1 | 0.745** | 0.321 | 0.345 | −0.482* |
| V | 0.951** | 0.745** | 1 | 0.821** | 0.782** | −0.303 |
| R | 0.690* | 0.321 | 0.821** | 1 | 0.634* | −0.228 |
| D | 0.818** | 0.345 | 0.782** | 0.634* | 1 | −0.491* |
| LM | −0.314 | −0.482* | −0.303 | −0.228 | −0.491* | 1 |

Q represents the relative building renewal quantity, S represents the absolute building renewal quantity, V represents the plot ratio renewal quantity, R represents the building density renewal quantity, D represents the functional density renewal quantity, and LM represents the functional mix renewal quantity; ** represents extremely strong correlation, and * represents strong correlation.

The correlation coefficients of the three indicators Q-S-V are all greater than 0.7; S represents the absolute renewal quantity of buildings within the station region, Q represents the relative renewal quantity, and the comprehensive analysis of the two can reflect the fluctuation of the station renewal intensity more comprehensively; the four indicators R-Q-V-D exhibit strong correlation between every two, point more to land use related characteristics, and are comprehensively summarized using land use intensity research elements in this method; the correlation coefficients of every two of LM-D-S are all greater than 0.4, and D and LM are directly related to the distribution characteristics of station functional formats and are therefore summarized as functional diversity research elements.

The correlation between the relative building renewal quantity Q, the absolute building renewal quantity S, and the plot ratio renewal quantity V is strong, and their comprehensive evaluation group points to a station renewal fluctuation research element. Due to the direct correlation of the calculation of the plot ratio indicator with building area and plot area, Q and V show obvious linear positive correlation, and the correlations of S with Q and V are similar. The absolute renewal quantity of buildings represents a total area of changed buildings within the station region in the renewal process, and its value reflects a renewal activity level of the overall station region. Meanwhile, the relative renewal quantity of buildings and the plot ratio renewal quantity objectively reflect the results of comparison before and after renewal of the station region. Therefore, the comprehensive analysis on the Q-S-V indicator group can obtain differentiated characteristics of a rail transit station renewal fluctuation dimension.

According to the correlation coefficients, the four indicators including building density renewal quantity R, relative building renewal quantity Q, plot ratio renewal quantity V, and functional density renewal quantity D can form new analysis groups. As mentioned above, Q and V show obvious positive correlation, but their comprehensive analysis with other different data can obtain different levels of characteristics. The correlation function relationships of the building density renewal quantity R with Q and S are similar, with correlation coefficients of 0.69 and 0.82, respectively. The correlation coefficient between the functional density renewal quantity D and Q is 0.82, which indirectly confirms that building renewals bring renewals of functional formats. The three indicators Q, V, and R can directly reflect land use within the station region. Therefore, the comprehensive analysis on the R-Q-V-D indicator group points to differentiated characteristics of a land use intensity dimension in the renewal process.

Among the functional mix renewal quantity LM, the functional density renewal quantity D, and the absolute building renewal quantity S, D and S show strong positive correlation. Therefore, the correlations of LM with D and S are similar, with correlation coefficients of −0.491 and −0.482, respectively, indicating moderate correlation. The following figures also show that LM is negatively correlated with the other two indicators, and their linear relationships are not very obvious. Due to the significant aggregation effect of functional formats in surrounding regions of rail transit stations in the renewal process, with the increase of S value, the densities of functional formats such as commercial/office that adapt to high-value land increase, while some scattered functions such as community services are integrated and replaced, resulting in a decrease in functional mix. Therefore, the group formed by LM, D, and S is used for comprehensively reflecting differentiated characteristics of a station functional diversity dimension.

Receive sample stations, designate the station renewal intensity definition indicators of the sample stations corresponding to different rail transit station intensity characteristic research elements as input variables, and perform clustering analysis to obtain definition results.

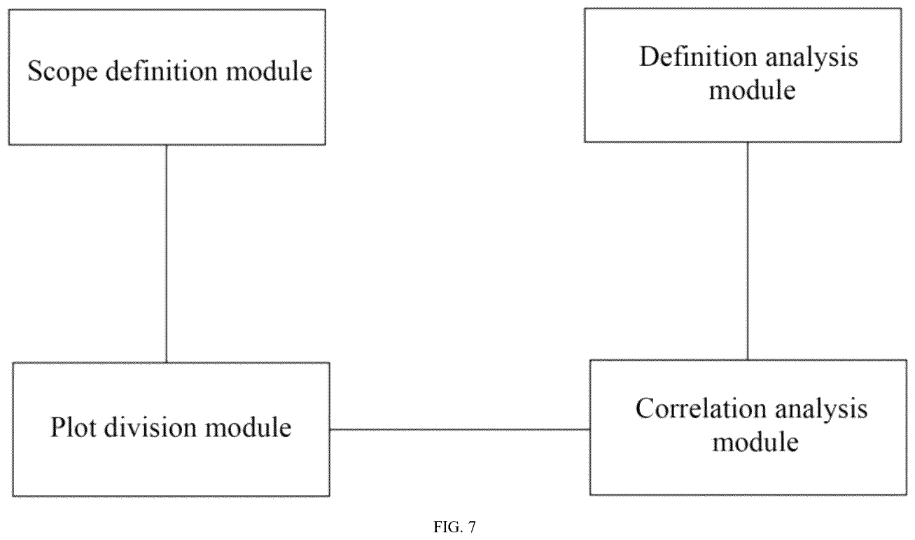

On the other hand, as shown in FIG. 7, the embodiment of the present invention discloses a system for defining a spatial renewal intensity of a rail transit station region based on multi-parameter collaboration, including:
a scope definition module, configured to receive an initial sample region, and define a scope of the initial sample region to obtain plots within the station region, where the initial sample region is divided by surrounding regions of rail transit stations;
a plot division module, configured to divide the plots within the station region to obtain different renewal types of plots, and calculate station renewal intensity definition indicators using the different renewal types of plots;
a correlation analysis module, configured to perform correlation analysis on the station renewal intensity definition indicators to obtain analysis results, generate different analysis groups according to the analysis results, and obtain rail transit station intensity characteristic research elements according to the analysis groups, where the rail transit station intensity characteristic research elements correspond to the station renewal intensity definition indicators; and
a definition analysis module, configured to receive sample stations, designate the station renewal intensity definition indicators of the sample stations corresponding to different rail transit station intensity characteristic research elements as input variables, and perform clustering analysis to obtain definition results.

Example 1: The first-stage project of subway line x in a city includes 12 stations as an example, including station 1, station 2, station 3, station 4, station 5, station 6, station 7, station 8, station 9, station 10, station 11, and station 12. The stations are of all types, including residential, commercial, historical block, and scenic region types from a functional perspective; old city region, urban center, and suburban types from an urban location perspective; and general, transfer, and transportation hub types from a traffic connection perspective, classified based on renewal intensities.

### (1) Determine a Station Region Research Scope

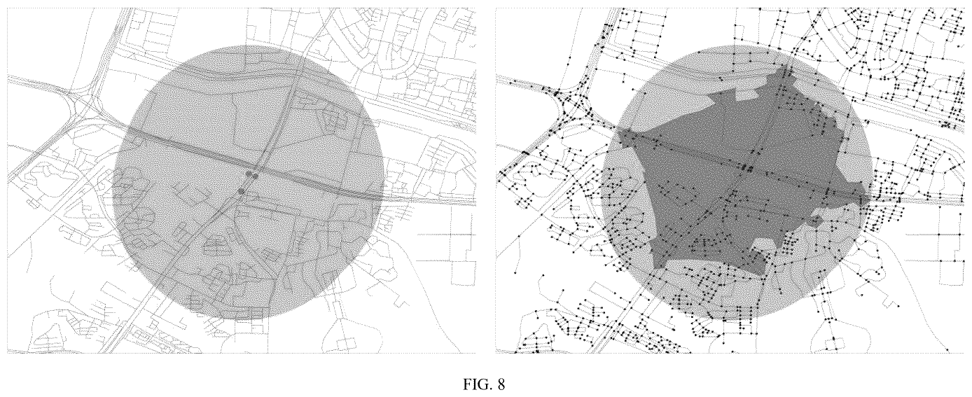

Starting from each entrance and exit of stations along subway line x in the city, an overlap scope that can be reached by walking for 10 minutes was designated as a research scope. Based on the current road network and the entrances and exits of rail transit stations, a road network dataset was built using Arcgis. The walking speed of people is usually 80-100 mm/min, so a walking range of people within ten minutes was calculated based on 80 m/min (see FIG. 8).

### (2) Station Region Information Statistics and Calculation

Land use type distribution maps of sample stations along subway line x in the city within the research scope in 2005 and 2020 were obtained using high-resolution remote sensing images, and the processed images were inserted into ArcGIS software as base maps to compare and draw boundary lines of different plot renewal types around the sample stations along subway line x in the city.

Network open source POI data information was obtained and then pre-processed, involving data cleaning and reclassification. The data cleaning mainly includes operations such as deleting duplicate data points with the same name and coordinates from the original data. The data reclassification refers to reclassification of POI data in the original OSM maps, such as deleting or merging temporarily unnecessary data such as place names, address information, and road ancillary facilities, to ultimately obtain POI data classes required for analysis content, including office, catering, hotel, shopping, government, transportation, education and culture, finance, sports and leisure, and residential. The ArcGIS collected statistics on the quantity of POIs within the station region as a data basis for calculating relevant indicators.

### (3) Statistics on Station Evaluation Indicators

6 indicators of 12 sample stations were calculated using SPSS according to the formulas of the evaluation indicators, followed by statistical processing.

| | Q | S | V | R | D | LM |
|---|---|---|---|---|---|---|
| Station 1 | 132365.24 | 178631.44 | 0.14 | 0.08 | 0.0011 | −0.0100 |
| Station 2 | 67796.90 | 116002.28 | 0.10 | 0.01 | 0.0008 | −0.0003 |
| Station 3 | −61534.75 | 96556.49 | −0.05 | −0.08 | 0.0003 | 0.0031 |
| Station 4 | 74424.12 | 312636.00 | 0.12 | −0.04 | 0.0011 | −0.0108 |
| Station 5 | −14341.20 | 344972.94 | −0.01 | −0.03 | 0.0014 | −0.0097 |
| Station 6 | 305538.96 | 323196.58 | 0.24 | 0.02 | 0.0014 | 0.0002 |
| Station 7 | 189034.20 | 358278.80 | 0.18 | 0.02 | 0.0026 | −0.0090 |
| Station 8 | 821230.97 | 881854.37 | 0.47 | 0.05 | 0.0037 | −0.0106 |
| Station 9 | 42110.38 | 354439.60 | 0.04 | 0.02 | 0.0021 | 0.0015 |
| Station 10 | 151717.29 | 319941.59 | 0.14 | −0.03 | 0.0020 | −0.0065 |
| Station 11 | −227868.66 | 303462.82 | −0.26 | −0.18 | 0.0004 | −0.0068 |
| Station 12 | −6824.64 | 197318.54 | −0.01 | −0.07 | 0.0003 | 0.0073 |

Q represents a relative building renewal quantity, S represents an absolute building renewal quantity, V represents a plot ratio renewal quantity, R represents a building density renewal quantity, D represents a functional density renewal quantity, and LM represents a functional mix renewal quantity.

### (4) Analysis on Correlation of Indicators

Correlation analysis in SPSS and Pearson correlation coefficients for verification were used herein, and 7 indicators were input as analysis variables to obtain results.

| | Q | S | V | R | D | LM |
|---|---|---|---|---|---|---|
| Q | 1 | 0.810** | 0.951** | 0.690* | 0.818** | −0.314 |
| S | 0.810** | 1 | 0.745** | 0.321 | 0.345 | −0.482* |
| V | 0.951** | 0.745** | 1 | 0.821** | 0.782** | −0.303 |
| R | 0.690* | 0.321 | 0.821** | 1 | 0.634* | −0.228 |
| D | 0.818** | 0.345 | 0.782** | 0.634* | 1 | −0.491* |
| LM | −0.314 | −0.482* | −0.303 | −0.228 | −0.491* | 1 |

Q represents a relative building renewal quantity, S represents an absolute building renewal quantity, V represents a plot ratio renewal quantity, R represents a building density renewal quantity, D represents a functional density renewal quantity, and LM represents a functional mix renewal quantity.

(5) Derive Research Elements from the Correlation Results of Evaluation Indicators

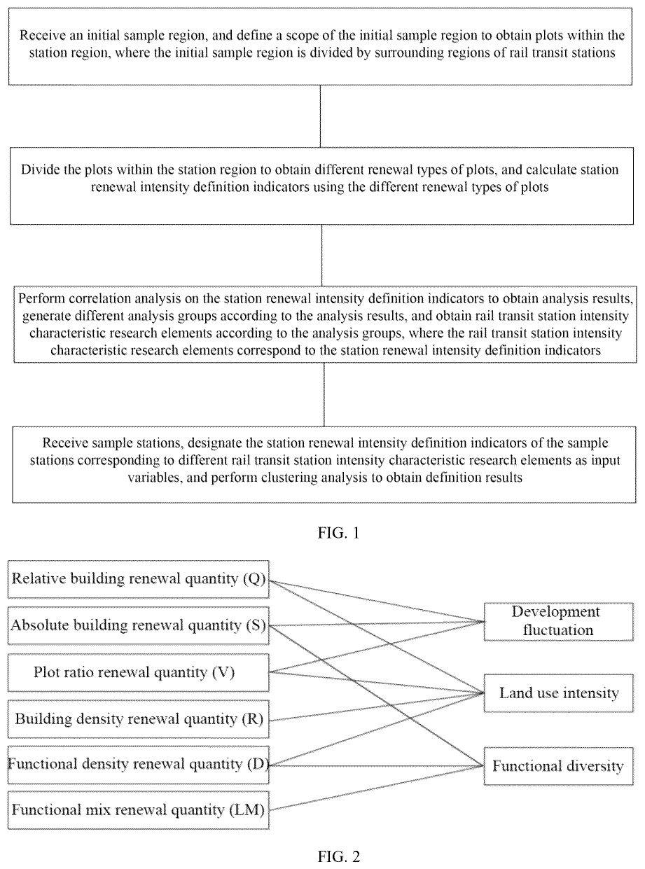

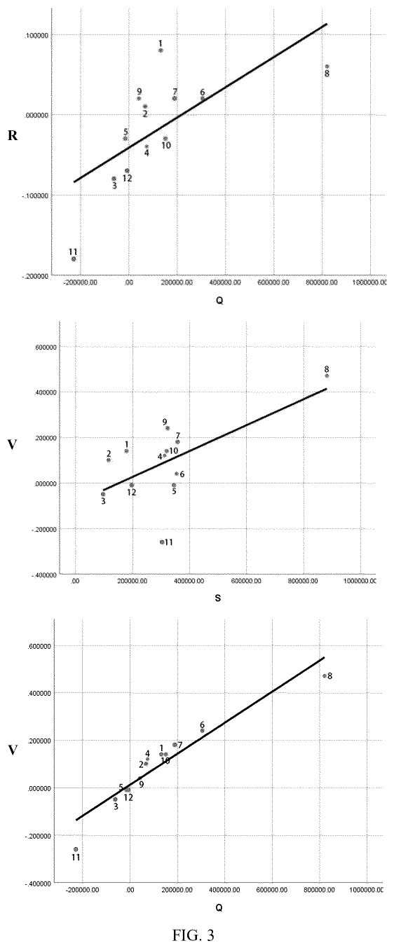

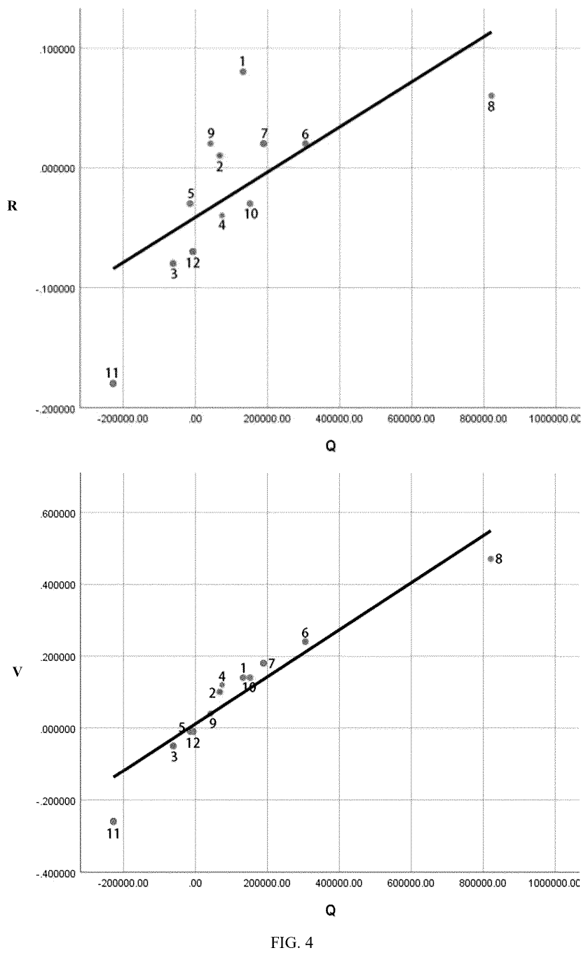

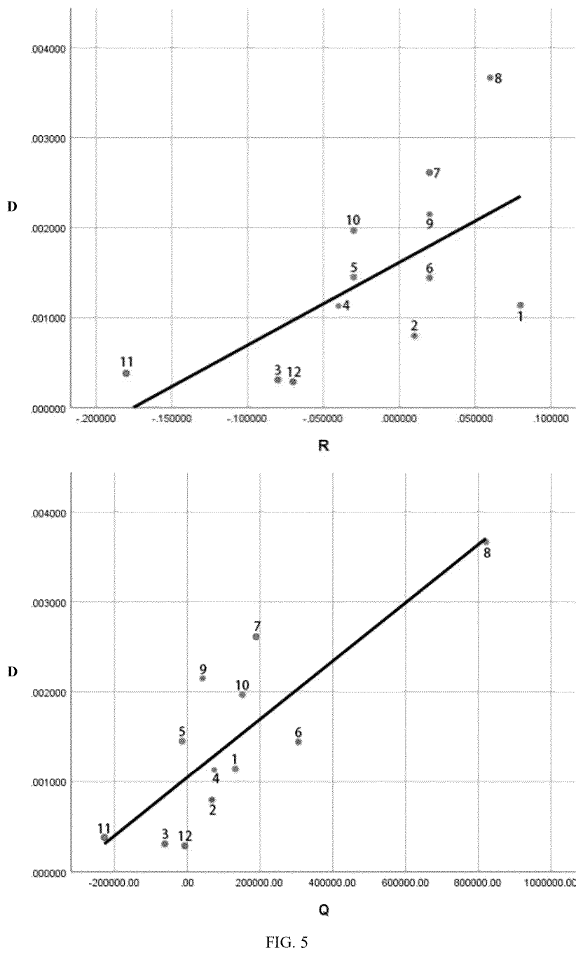

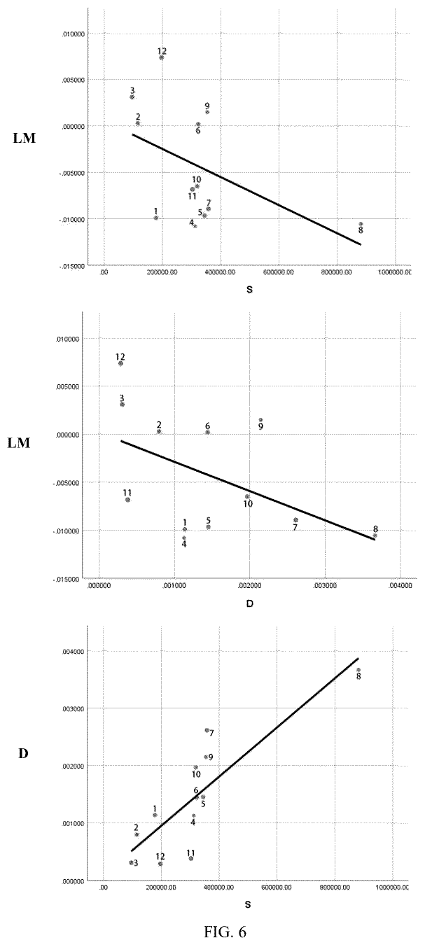

The correlation analysis results indicate different correlations and strong-weak correlations between the indicators. Therefore, the evaluation indicators form different analysis groups based on the correlation analysis results, and point to research elements of differentiated rail transit station intensity characteristics. The correlation coefficients of the three indicators Q-S-V are all greater than 0.7; S represents the absolute renewal quantity of buildings within the station region, Q represents the relative renewal quantity, and the comprehensive analysis of the two can reflect the fluctuation of the station renewal intensity more comprehensively; the four indicators R-Q-V-D exhibit strong correlation between every two, point more to land use related characteristics, and are comprehensively summarized using land use intensity research elements herein; the correlation coefficients of every two of LM-D-S are all greater than 0.4, and D and LM are directly related to the distribution characteristics of station functional formats and are therefore summarized as functional diversity research elements (see FIG. 2).

### (6) Station Clustering Under Different Renewal Intensity Elements

The classes of rail transit station stations divided from different perspectives had different station region renewal intensities. In order to explore the intensity differentiation characteristics of different research element dimensions, clustering analysis was performed based on the indicator data of 12 sample stations along subway line x in the city. Due to the significant differences in indicator values, the evaluation indicators related to different research elements were standardized, and then the standardized results were designated as input variables for clustering analysis in SPSS.

| | Q | S | V | R | D | LM |
|---|---|---|---|---|---|---|
| Station 1 | .03709 | −.68053 | .27269 | 1.39872 | −.29947 | −.89784 |
| Station 2 | −.21339 | −.99169 | .04702 | .40302 | −.63482 | .71578 |
| Station 3 | −.71510 | −1.08830 | −.79928 | −.87716 | −1.11332 | 1.15901 |
| Station 4 | −.18768 | −.01476 | .15986 | −.30819 | −.30928 | −1.04033 |
| Station 5 | −.53203 | .14589 | −.57360 | −.16595 | .00646 | −.85837 |
| Station 6 | .70888 | .03770 | .83689 | .54526 | −.00139 | .69935 |
| Station 7 | .25693 | .21200 | .49837 | .54526 | 1.14585 | −.74384 |
| Station 8 | 2.70940 | 2.81326 | 2.13454 | 1.11423 | 2.17836 | −1.00020 |
| Station 9 | −.31303 | .19293 | −.29150 | .54526 | .69087 | .90400 |
| Station 10 | .11216 | .02153 | .27269 | −.16595 | .51340 | −.35900 |
| Station 11 | −1.36036 | −.06034 | −1.98409 | −2.29959 | −1.04273 | −.41178 |
| Station 12 | −.50287 | −.58769 | −.57360 | −.73492 | −1.13392 | 1.83322 |

Q represents a relative building renewal quantity, S represents an absolute building renewal quantity, V represents a plot ratio renewal quantity, R represents a building density renewal quantity, D represents a functional density renewal quantity, and LM represents a functional mix renewal quantity.

### 1) Renewal Fluctuation Intensity

The renewal fluctuation of rail transit stations is mainly used for analyzing overall renewal intensity differentiation characteristics between different types of stations at a macro level, including three evaluation indicators: relative building renewal quantity Q, absolute building renewal quantity S, and plot ratio renewal quantity V.

| | Station | Clustering analysis |
|---|---|---|
| Station characteristics | name | spectrum pattern |
| Type III: | Station 4 | Between-class |
| Low renewal fluctuation intensity, | Station 10 | distance |
| mostly urban center type stations, | Station 8 | (see FIG. 9) |
| large area of unrenewed plots, | Station 7 | |
| and scattered distribution of | Station 5 | |
| the remaining renewed plots within | Station 9 | |
| the station region. | Station 1 | |
| | Station 2 | |
| | Station 3 | |
| | Station 6 | |
| Type II: | Station 12 | |
| Moderate renewal fluctuation | | |
| intensity, urban fringe stations. | | |
| Type I: | Station 11 | |
| High renewal fluctuation intensity, | | |
| a large number of decremental | | |
| renewal plots. | | |

### 2) Land Use Intensity

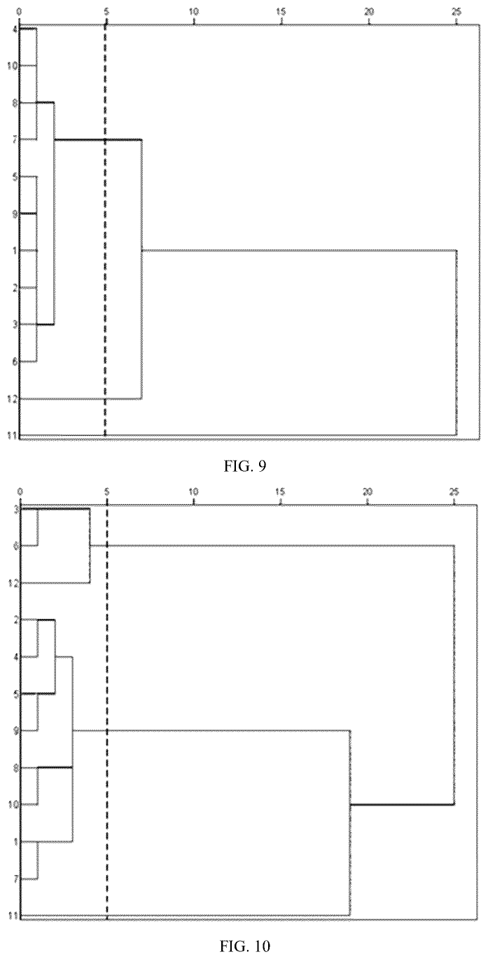

Land use intensity research elements mainly focus on differentiated characteristics of land use renewal intensity between plots within the rail transit station region. The standardized results of the relevant indicators of the sample stations, including building density renewal quantity R, relative building renewal quantity Q, plot ratio renewal quantity V, and functional density renewal quantity D, were input into SPSS as variables for clustering analysis. The results are shown in the following chart.

| | Station | Clustering analysis |
|---|---|---|
| Station characteristics | name | spectrum pattern |
| Type III: | Station 3 | Between-class |
| Low land use intensive renewal | Station 6 | distance |
| intensity, large scale of plot division | Station 12 | (see FIG. 10) |
| within the station region. | | |
| Type II: | Station 2 | |
| Moderate land use intensive renewal | Station 4 | |
| intensity, the stations in this clustering | Station 5 | |
| interval are mostly located in the | Station 9 | |
| urban center, focusing on commercial | Station 8 | |
| services and residential functions. | Station 10 | |
| | Station 1 | |
| | Station 7 | |
| Type I: | Station 11 | |
| High land use intensive renewal | | |
| intensity, manifested as decremental | | |
| renewal. | | |

### 3) Functional Diversity Intensity

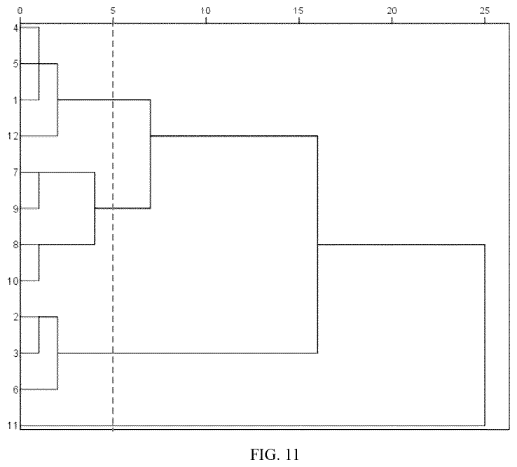

Functional diversity research elements are used for analyzing differentiated characteristics of renewal intensities of functional mix and aggregation in surrounding regions of rail transit stations. The standardized results of the relevant indicators of the sample stations, including functional mix renewal quantity LM, functional density renewal quantity D, and absolute building renewal quantity S, were designated as variables for clustering analysis. The results are shown in the following chart.

| | Station | Clustering analysis |
|---|---|---|
| Station characteristics | name | spectrum pattern |
| Type III: | Station 4 | Between-class |
| Low functional diversity | Station 5 | distance |
| renewal intensity, mostly urban | Station 1 | (see FIG. 11) |
| fringe stations. | Station 12 | |
| Type II: | Station 7 | |
| Moderate functional diversity | Station 9 | |
| renewal intensity, mostly located | Station 8 | |
| in urban center regions. | Station 10 | |
| Type I: | Station 2 | |
| High functional diversity | Station 3 | |
| renewal intensity, low renewal | Station 6 | |
| intensity of land planning layout | Station 11 | |
| within the station region | | |

Based on the same inventive concept, the present invention further provides a computer device, including: one or more processors, and a memory configured to store one or more computer programs; the program includes program instructions, and the processor is configured to execute the program instructions stored in the memory. The processor may be a central processing unit (CPU), or other general-purpose processors, digital signal processors (DSPs), application specific integrated circuits (ASICs), field-programmable gate arrays (FPGAs), or other programmable logic devices, discrete gate or transistor logic devices, discrete hardware components, etc. The processor is a computing core and a control core of a terminal, and is configured to implement one or more instructions, specifically to load and execute one or more instructions in a computer storage medium to implement the above method.

It should be further explained that, based on the same inventive concept, the present invention further provides a computer storage medium storing a computer program that, when executed by a processor, performs the above method. The storage medium may be any one or any combination of more computer-readable media. The computer-readable media may be computer-readable signal media or computer-readable storage media. For example, the computer-readable storage medium may be, but is not limited to, an electrical, magnetic, optical, magnetic, infrared, or semiconductor system, apparatus, or device, or any combination of the above. More specific examples (non-exhaustive list) of the computer-readable storage medium include: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical memory, a magnetic memory, or any suitable combination of the above. In the present invention, the computer-readable storage medium may be any tangible medium including or storing programs which can be used by an instruction execution system, apparatus or device or incorporated thereto.

In the description of this specification, the reference terms “one embodiment”, “example”, “specific example”, etc. indicate that the specific feature, structure, material, or characteristic described in conjunction with the embodiment or example is included in at least one embodiment or example of the present disclosure. In the specification, the schematic descriptions of the above terms do not necessarily refer to the same embodiment or example. Moreover, the described specific features, structures, materials or characteristics can be combined in any one or more embodiments or examples in a suitable manner.

The basic principles, main features and advantages of the present disclosure are shown and described above. Those skilled in the art should understand that the present disclosure is not limited by the above embodiments, the above embodiments and the descriptions only illustrate the principles of the present disclosure, the present disclosure has various changes and improvements without departing from the spirit and scope of the present disclosure, and these changes and improvements all fall within the scope of the present disclosure.

1. A method for defining a spatial renewal intensity of a rail transit station region based on a multi-parameter collaboration, wherein all steps are automatically executed by a processor of a computing system comprising a memory storing instructions implementing a scope definition module, a plot division module, a correlation analysis module, and a definition analysis module, and wherein outputs of each module are provided as inputs to a subsequent module by the processor, the method comprising the following steps:
defining a scope of an initial sample region to obtain plots within the rail transit station region, wherein the defining comprises building, by the processor executing geographic information system (GIS) software, a road network dataset based on a current road network and station entrances/exits, calculating, by the GIS software, a walking range within ten minutes from each entrance and exit using a walking-speed parameter of 80 m/min, and computing an overlap scope of the walking ranges;
dividing the plots within the rail transit station region to obtain different renewal types of plots, wherein the dividing comprises receiving high resolution remote sensing images from external sources and importing, by the processor into the GIS software, the high-resolution remote sensing images from at least two different time periods as base maps, automatically comparing the images and drawing boundary lines of different plot renewal types around the sample stations, classifying plots into different renewal types, and pre-processing point of interest (POI) data obtained from an open street map (OSM) database by deleting duplicate data points and reclassifying POI categories, and computing the quantity of POIs within the station region, and calculating station renewal intensity definition indicators using the different renewal types of plots and the computed POI quantities;
performing a correlation analysis on the station renewal intensity definition indicators to obtain analysis results, generating different analysis groups according to the analysis results, and obtaining rail transit station intensity characteristic research elements according to the different analysis groups, wherein the rail transit station intensity characteristic research elements correspond to the station renewal intensity definition indicators, wherein the correlation analysis is executed by the processor using a static package for social science and Pearson correlation coefficients; and
receiving, via an input interface, data identifying sample stations, standardizing the station renewal intensity definition indicators, designating the station renewal intensity definition indicators of the sample stations corresponding to different rail transit station intensity characteristic research elements as input variables, and performing a clustering analysis to obtain definition results, wherein the clustering analysis is executed by the processor in the static package for social science, wherein in the method, the station renewal intensity definition indicators comprise a relative building renewal quantity Q, an absolute building renewal quantity S, a plot ratio renewal quantity V, a building density renewal quantity R, a functional density renewal quantity D, and a functional mix renewal quantity LM, and wherein the method further comprises outputting the definition results and visualizing station-region renewal intensity via a data visualization function.

2. The method for defining the spatial renewal intensity of the rail transit station region based on the multi-parameter collaboration according to claim 1, wherein the plots within the rail transit station region are divided into decremental renewal plots, unrenewed plots, stock renewal plots, and incremental renewal plots.

3. The method for defining the spatial renewal intensity of the rail transit station region based on the multi-parameter collaboration according to claim 2, wherein the decremental renewal plots originally accommodate building functions and undertook urban functions but are currently demolished for construction or renewed into public spaces comprising a greenery and squares;
in the unrenewed plots, buildings and land use basically remain unchanged, with improvements only on appearance of some buildings, spatial quality, and urban environment;
in the stock renewal plots, buildings are replaced due to functional requirements or urban spatial planning adjustments and an overall development quantity of the buildings increases, decreases, or remains unchanged; and
the incremental renewal plots are initially planned for the construction or unplanned for development, but will be developed for buildings after a plurality of years.

4. (canceled)

5. The method for defining the spatial renewal intensity of the rail transit station region based on the multi-parameter collaboration according to claim 1, wherein a calculation formula for the relative building renewal quantity Q is as follows:
$$Q = A 1 - A 0$$
wherein A1 represents a total area of buildings after a renewal, A0 represents a total area of buildings before the renewal, and Q represents the relative building renewal quantity;
calculation formulas for the absolute building renewal quantity S are as follows:
$$S = \vert Qi \vert$$
$$\sum S = \sum \vert Qi \vert$$
wherein Qi represents relative building renewal quantities of different renewal plot types (i=1, 2, 3, 4, wherein 1, 2, 3, 4 represent decremental renewal plots, unrenewed plots, stock renewal plots, and incremental renewal plots, respectively), and S represents the absolute building renewal quantity;
a calculation formula for the plot ratio renewal quantity Vis as follows:
$$V = \frac{Q}{SM}$$
wherein Q represents the relative building renewal quantity; SM represents a total land area; V represents the plot ratio renewal quantity.

6. The method for defining the spatial renewal intensity of the rail transit station region based on the multi-parameter collaboration according to claim 1, wherein a calculation formula for the building density renewal quantity R is as follows:
$$R = \frac{{B}_{1} - {B}_{0}}{SM}$$
wherein B1 represents a total area of building lots after a renewal, and B0 represents a total area of building lots after the renewal; SM represents a total land area, and R represents the building density renewal quantity;
a calculation formula for the functional density renewal quantity D is as follows:
$$D = \frac{{P}_{1} - {P}_{0}}{SM}$$
wherein P1 represents a quantity of point of interests (POIs) within the rail transit station region after the renewal, and P0 represents a quantity of POIs within the rail transit station region before the renewal; SM represents the total land area; D represents the functional density renewal quantity;
calculation formulas for the functional mix renewal quantity LM are as follows:
$${F}_{u} = \frac{{n}_{u}}{N} ( u = 1 , 2 , 3 , … k )$$
$${LM}_{a} = - {\sum }_{u}^{k} {F}_{u} ln ( {F}_{u} ) ( a = 1 , 0 )$$
$$LM = {LM}_{1} - {LM}_{0}$$
wherein Fu represents a proportion of u-type functional POIs in a research region, k represents a total number of u types, and nu represents a quantity of the u-type functional POIs in the research region; N represents a total quantity of POI data in the research region; LMa represents a land functional mix within a research scope of the rail transit station region, a=1 represents a land functional mix after the renewal, a=0 represents a land functional mix before the renewal, and LM represents the functional mix renewal quantity.

7. The method for defining the spatial renewal intensity of the rail transit station region based on the multi-parameter collaboration according to claim 1, wherein a process of performing the correlation analysis on the station renewal intensity definition indicators uses the correlation analysis in a statistic package for social science (SPSS) and uses Pearson correlation coefficients for verification, 6 station renewal intensity definition indicators are input as analysis variables, and the analysis results about intensities of correlation between different station renewal intensity definition indicators are obtained by the correlation analysis.

8. The method for defining the spatial renewal intensity of the rail transit station region based on the multi-parameter collaboration according to claim 1, wherein the rail transit station intensity characteristic research elements comprise development fluctuation, land use intensity, and functional diversity.

9. (canceled)

10. A device, comprising:
at least one processor; and
a memory, configured to store at least one program, wherein
when the at least one program is executed by the at least one processor, the at least one processor is enabled to implement the method for defining the spatial renewal intensity of the rail transit station region based on the multi-parameter collaboration according to claim 1, by executing instructions implementing a scope definition module, a plot division module, a correlation analysis module, and a definition analysis module in a single integrated computing system, wherein outputs of each module are provided by the processor as inputs to a subsequent module via the memory, and including instructions that cause the processor to: build, in GIS software, a road network dataset and calculate ten-minute walking ranges from station entrances/exits based on an 80 m/min walking-speed parameter and compute an overlap scope; import into the GIS high-resolution remote-sensing images from different time periods as base maps, automatically compare the images to draw plot boundaries and classify plot renewal types; obtain and pre-process OSM POI data by deleting duplicates and reclassifying POI categories, and compute POI quantities within the station region; perform Pearson-correlation analysis and clustering analysis in SPSS using standardized indicator variables; and output the definition results and visualize station-region renewal intensity via a data visualization function.

11. The device according to claim 10, wherein in the method, the plots within the rail transit station region are divided into decremental renewal plots, unrenewed plots, stock renewal plots, and incremental renewal plots.

12. The device according to claim 11, wherein in the method, the decremental renewal plots originally accommodate building functions and undertook urban functions but are currently demolished for construction or renewed into public spaces comprising a greenery and squares;
in the unrenewed plots, buildings and land use basically remain unchanged, with improvements only on appearance of some buildings, spatial quality, and urban environment;
in the stock renewal plots, buildings are replaced due to functional requirements or urban spatial planning adjustments and an overall development quantity of the buildings increases, decreases, or remains unchanged; and
the incremental renewal plots are initially planned for the construction or unplanned for development, but will be developed for buildings after a plurality of years.

13. The device according to claim 10, wherein in the method, the station renewal intensity definition indicators comprise a relative building renewal quantity Q, an absolute building renewal quantity S, a plot ratio renewal quantity V, a building density renewal quantity R, a functional density renewal quantity D, and a functional mix renewal quantity LM.

14. The device according to claim 13, wherein in the method, a calculation formula for the relative building renewal quantity Q is as follows:
$$Q = A 1 - A 0$$
wherein A1 represents a total area of buildings after a renewal, A0 represents a total area of buildings before the renewal, and Q represents the relative building renewal quantity;
calculation formulas for the absolute building renewal quantity S are as follows:
$$S = \vert Qi \vert$$
$$\sum S = \sum \vert Qi \vert$$
wherein Qi represents relative building renewal quantities of different renewal plot types (i=1, 2, 3, 4, wherein 1, 2, 3, 4 represent decremental renewal plots, unrenewed plots, stock renewal plots, and incremental renewal plots, respectively), and S represents the absolute building renewal quantity;
a calculation formula for the plot ratio renewal quantity Vis as follows:
$$V = \frac{Q}{SM}$$
wherein Q represents the relative building renewal quantity; SM represents a total land area; V represents the plot ratio renewal quantity.

15. The device according to claim 13, wherein in the method, a calculation formula for the building density renewal quantity R is as follows:
$$R = \frac{{B}_{1} - {B}_{0}}{SM}$$
wherein B1 represents a total area of building lots after a renewal, and B0 represents a total area of building lots after the renewal; SM represents a total land area, and R represents the building density renewal quantity;
a calculation formula for the functional density renewal quantity D is as follows:
$$D = \frac{{P}_{1} - {P}_{0}}{SM}$$
wherein P1 represents a quantity of POIs within the rail transit station region after the renewal, and P0 represents a quantity of POIs within the rail transit station region before the renewal; SM represents the total land area; D represents the functional density renewal quantity;
calculation formulas for the functional mix renewal quantity LM are as follows:
$${F}_{u} = \frac{{n}_{u}}{N} ( u = 1 , 2 , 3 , … k )$$
$${LM}_{a} = - {\sum }_{u}^{k} {F}_{u} ln ( {F}_{u} ) ( a = 1 , 0 )$$
$$LM = {LM}_{1} - {LM}_{0}$$
wherein Fu represents a proportion of u-type functional POIs in a research region, k represents a total number of u types, and nu represents a quantity of the u-type functional POIs in the research region; N represents a total quantity of POI data in the research region; LMa represents a land functional mix within a research scope of the rail transit station region, a=1 represents a land functional mix after the renewal, a=0 represents a land functional mix before the renewal, and LM represents the functional mix renewal quantity.

16. The device according to claim 10, wherein in the method, a process of performing the correlation analysis on the station renewal intensity definition indicators uses the correlation analysis in an SPSS and uses Pearson correlation coefficients for verification, 6 station renewal intensity definition indicators are input as analysis variables, and the analysis results about intensities of correlation between different station renewal intensity definition indicators are obtained by the correlation analysis.

17. The device according to claim 10, wherein in the method, the rail transit station intensity characteristic research elements comprise development fluctuation, land use intensity, and functional diversity.
